(19) United States
(12) Patent Application Publication
(10) Pub. No.: US 2025/0344268 A1
(43) Pub. Date: Nov. 6, 2025

(54) WIRELESS COMMUNICATION SYSTEM, CONTROL APPARATUS, CONNECTION CONTROL METHOD, AND PROGRAM

(71) Applicant: NIPPON TELEGRAPH AND TELEPHONE CORPORATION, Tokyo (JP)

(72) Inventors: Toshiro NAKAHIRA, Tokyo (JP); Daisuke MURAYAMA, Tokyo (JP); Takeru FUKUSHIMA, Tokyo (JP); So TAKATANI, Tokyo (JP); Takatsune MORIYAMA, Tokyo (JP)

(21) Appl. No.: 18/873,496

(22) PCT Filed: Jul. 19, 2022
(86) PCT No.: PCT/JP2022/028115

§ 371 Date: Dec. 10, 2024

(51) Int. Cl. H04W 76/15

(52) U.S. Cl. CPC H04W 76/15

(57) ABSTRACT

In a wireless communication system including one or more base station devices, which communicate with one or more terminal devices, and a control apparatus, the control apparatus includes a terminal cluster calculation unit that performs clustering on a plurality of terminal devices and divides the plurality of terminal devices into a plurality of clusters, and a connection control unit that generates a plurality of combination patterns in which the base station device to be a connection destination of the terminal devices is allocated to each cluster, calculates an evaluation index value of each combination pattern, selects a combination pattern having a best evaluation index value, and performs control for connecting the terminal devices to the base station device based on the selected combination pattern.

### TECHNICAL FIELD

The present invention relates to a connection control technique of a terminal device in a wireless communication system.

### BACKGROUND ART

Connection control (also referred to as accommodation control) for controlling to which cell (base station device) each terminal device is connected is important to determine communication quality in a wireless communication system. In particular, a multilayer cell configuration using various radio access technologies (RATs) is assumed in wireless access such as 5G, and thus connection control is important.

Non-Patent Literature 1 discloses a cell selection connection control technique in which required conditions of a terminal device and the like and a characteristic of each RAT are considered in the multilayer cell configuration.

### CITATION LIST

### Non-Patent Literature

Non Patent Literature 1: Kishida et al., “A Study of Multi-Domain Radio Resource Management based on Service Types and User Preferences”, IEICE Technical Report, vol. 116, no. 110, RCS2016-52, pp. 35-40, June 2016

### SUMMARY OF INVENTION

### Technical Problem

However, each terminal device is individually controlled by the conventional connection control technique, and thus an amount of operation required for connection control becomes enormous as the number of terminal devices increases. Therefore, necessary calculation resources and time required for operation increase, and, as a result, problems such as an increase in equipment cost and a control delay may occur. Those problems may occur not only in the multilayer cell configuration but also in general wireless communication systems.

The present invention has been made in view of the above points, and an object thereof is to provide a technique capable of performing connection control of terminal devices with a small amount of operation even in a case where the number of terminal devices is large.

### Solution to Problem

The disclosed technique provides a wireless communication system including one or more base station devices, which communicate with one or more terminal devices, and a control apparatus, in which

the control apparatus includes

a terminal cluster calculation unit that performs clustering on a plurality of terminal devices and divides the plurality of terminal devices into a plurality of clusters, and

a connection control unit that generates a plurality of combination patterns in which the base station device to be a connection destination of the terminal devices is allocated to each cluster, calculates an evaluation index value of each combination pattern, selects a combination pattern having a best evaluation index value, and performs control for connecting the terminal devices to the base station device based on the selected combination pattern.

### Advantageous Effects of Invention

The disclosed technique provides a technique capable of performing connection control of terminal devices with a small amount of operation even in a case where the number of terminal devices is large.

### BRIEF DESCRIPTION OF DRAWINGS

FIG. 1 shows an overall configuration example of a wireless communication system.

FIG. 2 shows an overall configuration example of a wireless communication system.

FIG. 3 is a flowchart showing an operation of a control apparatus.

FIG. 4 shows an example of a plurality of clusters.

FIG. 5 shows an example of a combination pattern.

FIG. 6 shows a method of calculating a communication request achievement rate.

FIG. 7 shows a device configuration example.

FIG. 8 shows a hardware configuration example of a device.

### DESCRIPTION OF EMBODIMENTS

Hereinafter, an embodiment (present embodiment) of the present invention will be described with reference to the drawings. The embodiment described below is merely an example, and embodiments to which the present invention is applied are not limited to the following embodiment.

### Overview of Embodiment

In a wireless communication system, which base station device each terminal device is connected to is important. As described above, in the conventional technique, there is a problem that an amount of operation becomes enormous in a case where the number of terminal devices is large.

Therefore, in the present embodiment, terminal devices are clustered, and an accommodation destination base station device is selected for each terminal cluster. This reduces combinations of accommodation in terminal accommodation control and reduces the amount of operation.

Clustering may be performed based on positions of the terminal devices or may be performed according to characteristics such as a use application and a communication requirement of the terminal devices. Further, the terminal accommodation control and operation mode control (e.g. capacity priority or delay priority) of the base station device may be combined. Hereinafter, the “use application” will be referred to as a “use app”.

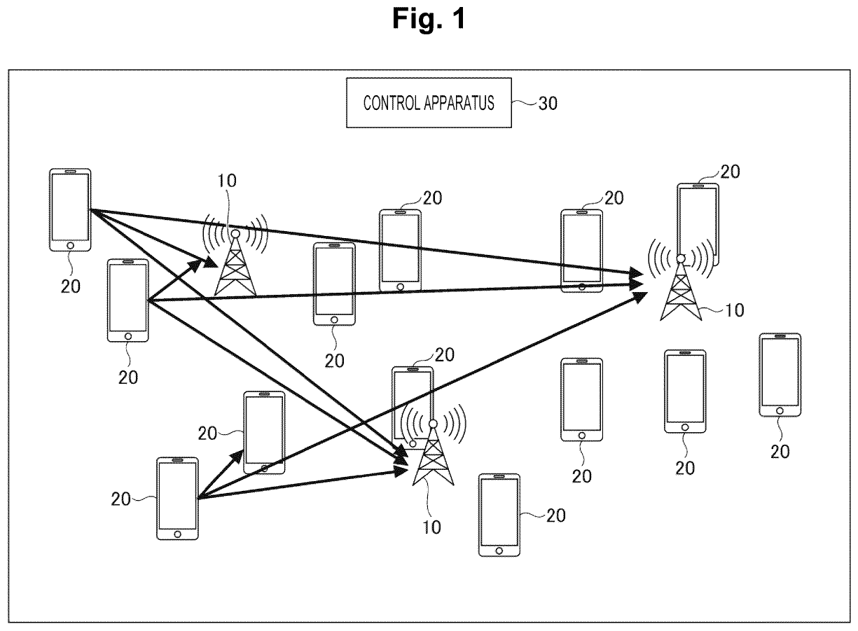

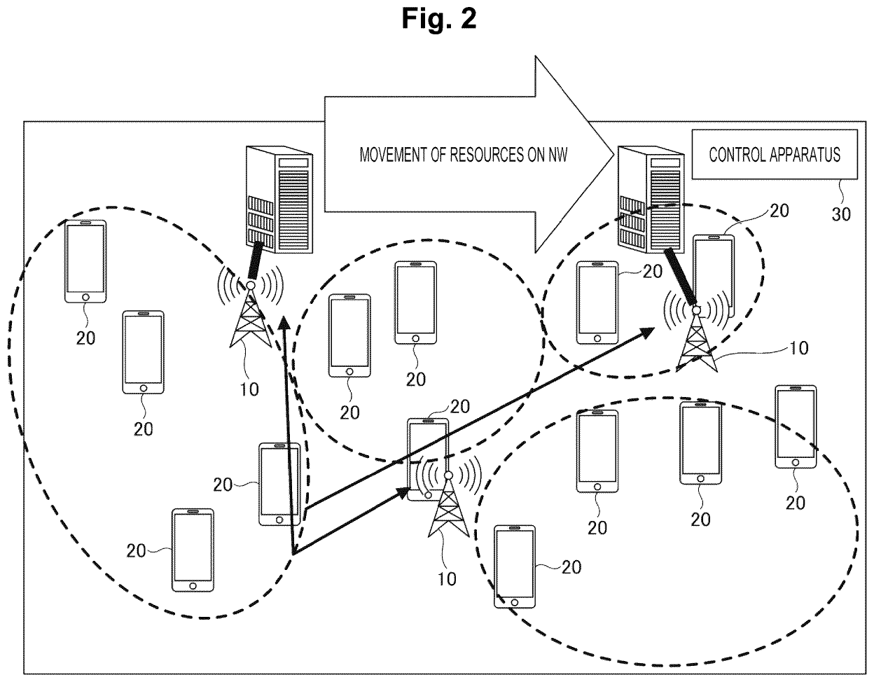

With the above processing, it is possible to perform control to connect the terminal devices to an appropriate base station device with a small amount of operation even in a case where the number of terminal devices increases. An overview of the processing will be described with reference to FIGS. 1 and 2.

FIGS. 1 and 2 each show a system configuration in which a plurality of base station devices 10 and a plurality of terminal devices 20 exist in the present embodiment. A control apparatus 30 performs connection control. Note that FIG. 1 shows a conventional control image not using the technique according to the present invention, and FIG. 2 shows a control image using the technique according to the present invention.

The base station device 10 may be a base station device in a cellular communication network (e.g. 3G, 4G/LTE, 5G, or 6G), a base station device in a wireless LAN, or a base station device in a communication method other than those methods. The terminal device 20 can wirelessly communicate with one or a plurality of base station devices 10.

The control apparatus 30 may be connected to each base station device 10 in a wired or wireless manner. The control apparatus 30 may be provided in, for example, a core network of a mobile network, the Internet, or a network other than those networks. A function of the control apparatus 30 may be provided in the base station device 10 or the terminal device 20. Both the base station device 10 and the terminal device 20 having the function of the control apparatus 30 may be referred to as a “control apparatus”.

In the example of FIG. 1, the control apparatus 30 individually performs accommodation control of the terminal devices 20, and thus the amount of operation is enormous. Meanwhile, in the example of FIG. 2, the control apparatus 30 clusters the terminal devices 20 and selects a connection destination base station device 10 for each terminal cluster, thereby reducing the amount of operation. In the example of FIG. 2, it is also possible to move resources (e.g. service provision server) on the network in accordance with the selection of the connection destination base station device 10.

### Operation Example of System

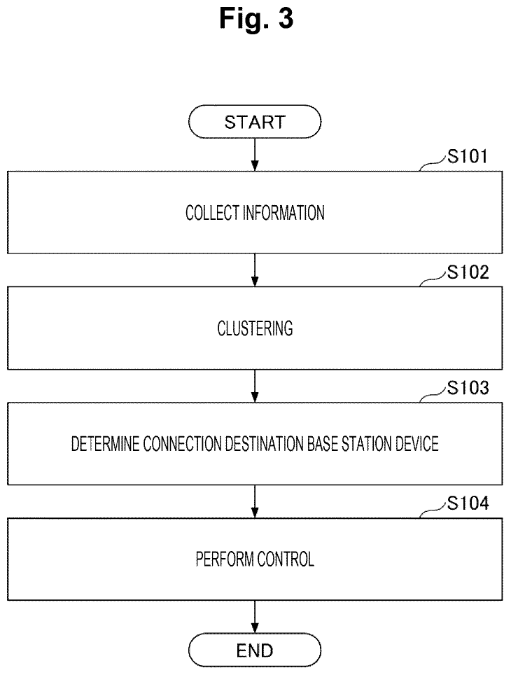

Next, an operation of the control apparatus 30 will be described along a procedure of the flowchart of FIG. 3. In the operation described below, it is assumed that there is an area that the control apparatus 30 is in charge of (referred to as a target area) and that the terminal device 20 and the base station device 10 in the target area are targets to be controlled. One or a plurality of terminal devices 20 and one or a plurality of base station devices 10 exist in the target area. In the present embodiment, a position of each base station device 10 is fixed, and the control apparatus 30 holds information such as the position of each base station device 10. However, the base station device 10 is not limited to being fixed. The technique according to the present invention is also applicable to a case where the base station device 10 moves.

Regarding communication between the base station device 10 and the terminal device 20 in the present embodiment, only a downlink may be considered, only an uplink may be considered, or both the downlink and the uplink may be considered. For example, a “throughput of the terminal device 20” may be a downlink throughput in the terminal device 20, an uplink throughput in the terminal device 20, or a total throughput of the downlink throughput and the uplink throughput in the terminal device 20.

Control of the procedure described below may be periodically performed, may be performed in response to an instruction from a system administrator, or may be performed at other timings.

### <S101>

In S101, the control apparatus 30 acquires a position (position information) of each terminal device 20. The position of the terminal device 20 may be acquired by any method. For example, a positioning technique standardized in 3GPP may be used to acquire the position.

### <S102>

In S102, the control apparatus 30 performs clustering processing on the plurality of terminal devices 20 in the target area and divides the plurality of terminal devices 20 into a plurality of clusters (terminal clusters). Any method may be used as the clustering method, and, for example, k-means method or hierarchical clustering can be used.

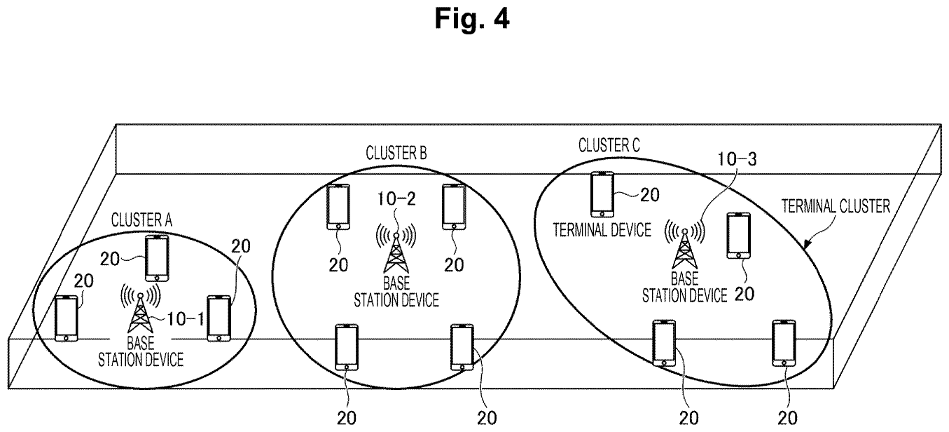

FIG. 4 shows an example where the plurality of terminal devices 20 is divided into three clusters A to C based on their positions.

Note that performing clustering based on the positions of the terminal devices 20 is an example of performing clustering by using a characteristic of the terminal devices 20. The clustering method is not limited thereto. The clustering may be performed by using the following characteristics. The clustering may also be performed by using a plurality of characteristics.

For example, the control apparatus 30 may acquire information regarding the use app of each terminal device 20 in S101 and perform clustering based on the use app in S102. Further, the control apparatus 30 may acquire information regarding a communication requirement of each terminal device 20 in S101 and perform clustering based on the communication requirement in S102.

In the clustering based on the use app, the clustering can be performed from the viewpoint of, for example, an application that requires low-delay communication but does not require large-capacity communication, an application that does not require low-delay communication but requires large-capacity communication, or an application that requires low-delay communication and large-capacity communication.

The communication requirement of the terminal device 20 may be a communication quality requirement (e.g. the throughput needs to be at least 100 Mbps), a communication characteristic requirement (e.g., communication can be performed even if radio waves are shielded by an obstacle), or a combination thereof.

In the clustering based on the communication requirement, assuming that there are five requirements, for example, information indicating which requirement needs to be satisfied in each terminal device is vectorized as (1, 0, 1, 1, 0). (1, 0, 1, 1, 0) means that, among (requirement 1, requirement 2, requirement 3, requirement 4, and requirement 5), the requirement 1, the requirement 3, and the requirement 4 need to be satisfied. Then, for example, the clustering is performed by using a distance between the vectors.

### <S103>

In S103, the control apparatus 30 first extracts a possible base station device 10 to be a connection destination of the terminal device 20 in units of the divided terminal clusters, and generates a plurality of combination patterns of the connection destination base station devices 10 in units of the terminal clusters.

Then, the control apparatus 30 selects a pattern having the highest evaluation index value (e.g., a communication request achievement rate) from among the plurality of combination patterns, and determines this pattern as the connection destination base station for each terminal cluster.

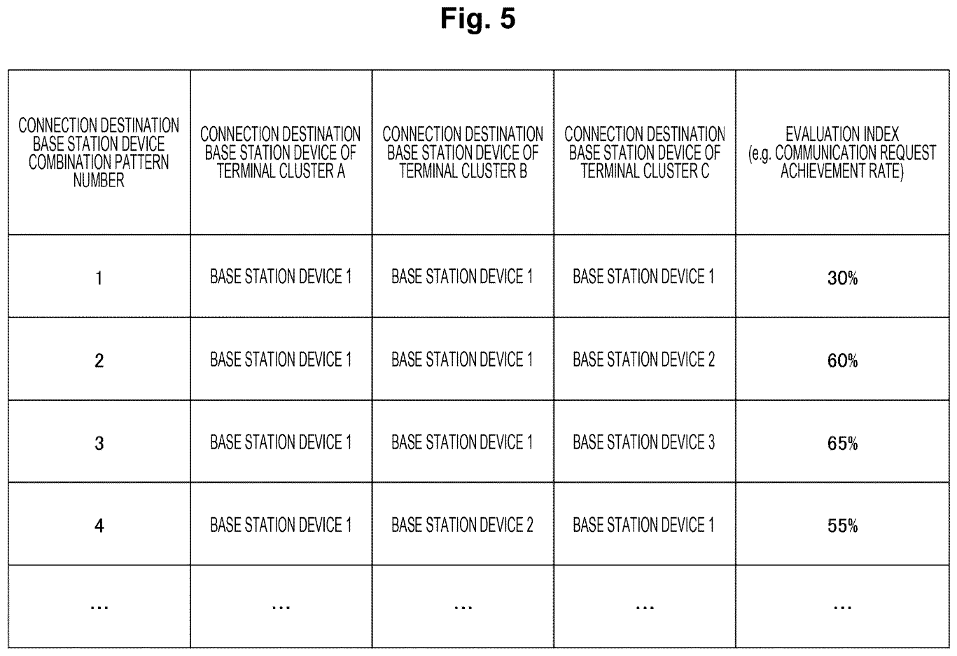

A pattern selection example will be described with reference to FIG. 5. The example of FIG. 5 assumes a clustering result shown in FIG. 4, and three terminal clusters A, B, and C are obtained. In FIG. 5, for convenience of description, a “base station device 10-1” in FIG. 4 will be described as a “base station device 1”. The same applies to the other base station devices 10.

For example, in a combination pattern 1 of FIG. 5, the connection destination base station device 10 of the terminal cluster A is the base station device 1, the connection destination base station device 10 of the terminal cluster B is the base station device 1, and the connection destination base station device 10 of the terminal cluster C is the base station device 1. The evaluation index value at this time (here, the communication request achievement rate) is 30%. A method of calculating the communication request achievement rate will be described later.

When considered in the range shown in FIG. 5, a combination pattern 3 has the best evaluation index value, and thus the control apparatus 30 determines the base station device 1 as the connection destination base station device 10 of each terminal device 20 in the terminal cluster A, the base station device 1 as the connection destination base station device 10 of each terminal device 20 in the terminal cluster B, and the base station device 3 as the connection destination base station device 10 of each terminal device 20 in the terminal cluster C.

### <S104>

In S104, the control apparatus 30 performs control to connect each terminal device 20 to the connection destination base station device 10 for each terminal cluster based on the pattern selection result in S103. Any method may be used as the control method here.

For example, in a case where a certain terminal device 20 transmits a connection request to the control apparatus 30 via a certain base station device 10, the control apparatus 30 issues, to the terminal device 20 that has transmitted the connection request, an instruction in the base station device 10 to which the terminal device 20 is to be connected. The terminal device 20 transmits a connection request to the base station device 10 as instructed by the control apparatus 30.

Note that, as described above, the control apparatus 30 may perform only connection control of the terminal devices 20 to the connection destination base station device 10 for each terminal cluster, or may perform not only the connection control, but also control of an operation mode or parameter of the base station device 10 in accordance with the terminal cluster to be accommodated.

For example, in a case where the communication requirement in the terminal cluster accommodated by the base station device 10 is a high resistance to radio wave blocking (being communicable even if there is an obstacle), the control apparatus 30 sets the operation mode or the parameter in the base station device 10 such that communication between the base station device 10 and each terminal device 20 in the terminal cluster is performed at a frequency of the low frequency band.

It is also possible to set a capacity-prioritized operation mode in the base station device 10 to be connected to a terminal cluster that prioritizes capacity, and set a low-delay-prioritized operation mode in the base station device 10 to be connected to a terminal cluster that prioritizes low delay.

The control apparatus 30 may perform only connection control (or only connection control and operation mode/parameter control) of the terminal devices 20 to the connection destination base station device 10 for each terminal cluster, or may not only perform connection control (or connection control and operation mode/parameter control), but also move a network resource such as a server on a network edge that is connected to the base station device 10 to provide a service for the terminal devices 20 in accordance with control of the connection destination base station device 10.

For example, a server A (which is assumed to be a virtual server) is connected to the base station device 10-1 at a certain time, and a service is provided by the server A for a terminal cluster belonging to the base station device 10-1. At another time, a terminal cluster for which the service is to be provided by the server A is connected to a base station device 10-2 in accordance with movement of the terminal device 20. At this time, the control apparatus 30 moves the server A to a network edge environment (e.g. a location including a physical server) near the base station device 10-2.

### Method of Calculating Communication Request Achievement Rate

Here, an example of the method of the control apparatus 30 calculating the communication request achievement rate will be described. Note that the communication request achievement rate corresponds to a ratio of the number of terminal devices that can satisfy a required communication quality when connected to a base station device to the total number of terminal devices.

The control apparatus 30 calculates the communication request achievement rate by the following procedures (S1 to S4). In the following procedures, the control apparatus 30 has already collected a communication request throughput of each terminal device.

### S1:

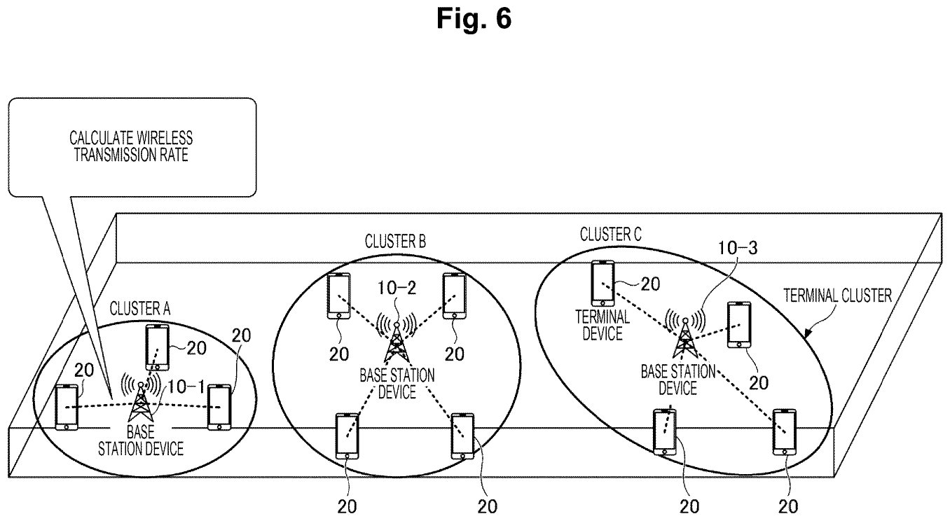

The control apparatus 30 calculates (estimates) a wireless transmission rate between each terminal device 20 and the base station device 10 serving as a connection destination. The wireless transmission rate can be calculated from, for example, an estimated value of received power in the terminal device 20. A calculation image of the wireless transmission rate is shown in FIG. 6.

### S2:

The control apparatus 30 divides the communication request throughput by the wireless transmission rate calculated in S1, for each terminal device 20 to be connected to the base station device 10, and calculates a communication resource use rate (base station communication resource use rate) of the base station device 10.

### S3:

The control apparatus 30 accommodates the terminal devices 20 in the base station device 10 in ascending order of the base station communication resource use rate and terminates terminal accommodation processing on the base station device 10 at a point of time when a total base station communication resource use rate of the accommodated terminal devices 20 exceeds 1.

For example, in a case where the base station communication resource use rate of a terminal device 20A is 0.3, the base station communication resource use rate of a terminal device 20B is 0.4, and the base station communication resource use rate of a terminal device 20C is 0.5, the control apparatus 30 accommodates the terminal device 20A and the terminal device 20B in the base station device 10 and attempts to accommodate the terminal device 20C in the base station device 10. If the terminal device 20C is accommodated therein, the total base station communication resource use rate exceeds 1, and thus the terminal accommodation processing is terminated at a point of time when the terminal device 20B is accommodated. At this time, the accommodated terminal devices are the terminal devices 20A and 20B.

### S4:

The control apparatus 30 performs the above processing for each connection destination base station combination pattern and for each base station device, calculates a ratio of the number of accommodated terminal devices 20 to the total number of terminal devices 20 in the target area for each connection destination base station combination pattern, and sets the ratio as the communication request achievement rate.

In the above example, the communication request throughput of the terminal device 20 can be grasped by the control apparatus 30, and the calculation of the communication request achievement rate using a value of the communication request throughput has been described.

However, connection control can be performed even in a case where the communication request throughput of the terminal device 20 cannot be grasped by the control apparatus 30. In this case, for example, the control apparatus 30 assumes the communication request throughput of each terminal device 20 to be a constant value and calculates the communication request achievement rate on that assumption. Even in a case where this assumption is used, it is possible to perform connection control assumed to easily satisfy the communication request throughput as much as possible.

In the above example, the terminal devices 20 are accommodated in the corresponding base station device 10 in ascending order of the base station communication resource use rate, but the accommodation method is not limited to this method. For example, an accommodation priority may be given to the terminal devices 20, and a terminal device 20 having a high priority may be preferentially accommodated.

For example, the order of the priority is the terminal device 20C>the terminal device 20B>the terminal device 20A. At this time, in a case where the base station communication resource use rate of the terminal device 20A is 0.3, the base station communication resource use rate of the terminal device 20B is 0.4, and the base station communication resource use rate of the terminal device 20C is 0.5, the control apparatus 30 accommodates the terminal device 20C and the terminal device 20B in the base station device 10 and attempts to accommodate the terminal device 20A in the base station device 10. If the terminal device 20A is accommodated therein, the total base station communication resource use rate exceeds 1, and thus the terminal accommodation processing is terminated at a point of time when the terminal device 20B is accommodated. At this time, the accommodated terminal devices are the terminal devices 20C and 20B.

### Another Example of Evaluation Index

Using the communication request achievement rate as the evaluation index used to select the connection destination base station combination pattern is an example. An evaluation index other than the communication request achievement rate may be used.

For example, as the evaluation index used to select the connection destination base station combination pattern, a degree of satisfaction of communication to a user of the terminal device 20, QoE of the user of the terminal device 20, or the like may be used as the evaluation index, or a plurality of evaluation indexes may be used in combination.

Both the degree of satisfaction and QoE described above can be estimated from, for example, a communication delay, throughput, and the like estimated in the terminal device 20.

For example, in a case where QoE is used as the evaluation index, the evaluation index in a certain connection destination base station combination pattern may be an average of QoE in all the target terminal devices 20, or may be a ratio of the number of terminal devices 20 that satisfy QoE (or predetermined QoE) required in the terminal devices 20 to all the target terminal devices 20.

### Apparatus Configuration Example

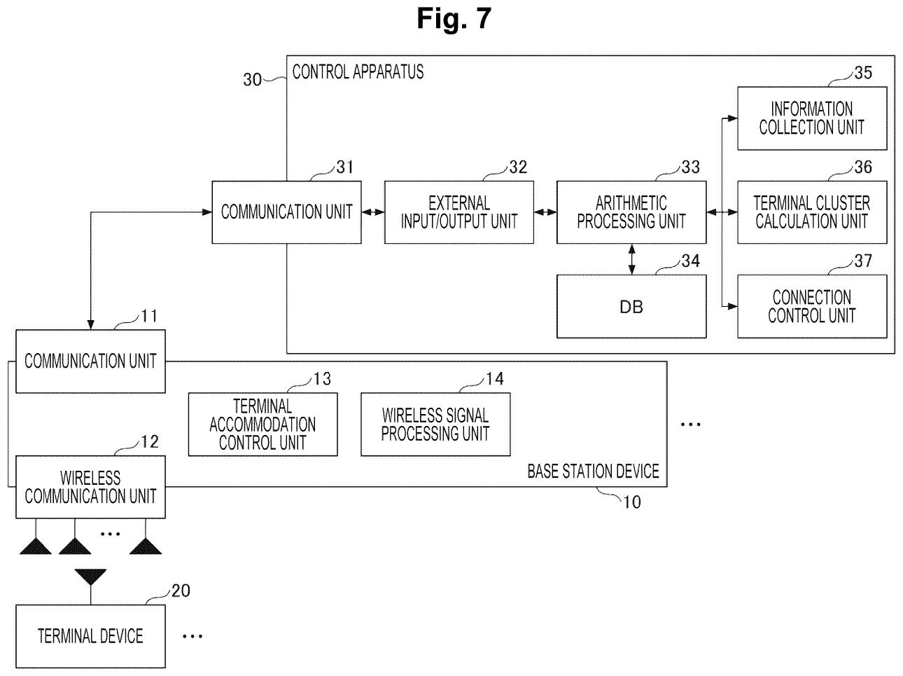

Next, an apparatus configuration example of an apparatus forming the wireless communication system will be described with reference to FIG. 7. FIG. 7 shows a configuration of an apparatus particularly related to the connection control in detail.

As shown in FIG. 7, the control apparatus 30 includes a communication unit 31, an external input/output unit 32, an arithmetic processing unit 33, a database (DB) 34, an information collection unit 35, a terminal cluster calculation unit 36, and a connection control unit 37.

The communication unit 31 is connected to a network to perform information communication. The external input/output unit 32 passes information received via the communication unit 31 to the arithmetic processing unit 33 and outputs information received from the arithmetic processing unit 33 to the outside via the communication unit 31.

The arithmetic processing unit 33 stores information in the DB 34 and reads information from the DB 34, for example.

The information collection unit 35 acquires information from the outside via the communication unit 31, the external input/output unit 32, and the like. For example, the information collection unit 35 acquires a position, use app, communication requirement (including a communication request throughput), and the like of each terminal device 20. The acquired information is stored in the DB 34 and is read and used by the terminal cluster calculation unit 36 and the connection control unit 37.

The terminal cluster calculation unit 36 performs clustering on the plurality of terminal devices 20 as described with reference to the flowchart of FIG. 3. A clustering result is stored in the DB 34 and is read and used by the connection control unit 37.

As described with reference to the flowchart of FIG. 3, the connection control unit 37 calculates (determines) the base station device 10 to which the terminal devices 20 are connected for each terminal cluster. In the process of calculating the base station device 10 to which the terminal devices 20 are connected, the connection control unit 37 stores information of the table of FIG. 5 in the DB 34 and accesses the DB 34 to perform the calculation.

The connection control unit 37 performs control such that each terminal device 20 is connected to the determined connection destination base station device 10. The connection control unit 37 can also control the operation mode, parameter, and the like of the base station device 10. Further, the connection control unit 37 can also perform movement control of the network resource described above.

The base station device 10 includes a communication unit 11, a wireless communication unit 12, a terminal accommodation control unit 13, and a wireless signal processing unit 14. The communication unit 11 performs information communication with, for example, the control apparatus 30 via a network. The wireless communication unit 12 wirelessly communicates with the terminal device 20. The wireless signal processing unit 14 performs, for example, conversion processing between a wireless signal and data.

The terminal accommodation control unit 13 performs control for accommodating the terminal device 20, for example, receives a connection request from the terminal device 20 and returns a response signal to the terminal device 20. The terminal accommodation control unit 13 also performs control to transmit the connection request received from the terminal device 20 to the control apparatus 30 and return information of the connection destination base station device 10 received from the control apparatus 30 to the terminal device 20.

### Hardware Configuration Example

The terminal device 20, the base station device 10, and the control apparatus 30 can all be implemented by, for example, causing a computer to execute a program. The computer may be a physical computer or may be a virtual machine on a cloud. Hereinafter, “the terminal device 20, the base station device 10, and the control apparatus 30” will be collectively referred to as a “device”.

That is, the device can be implemented by executing a program corresponding to processing performed by the device by using hardware resources such as a CPU and a memory built in the computer. The above program can be stored and distributed by being recorded in a computer-readable recording medium (e.g. portable memory). Further, the above program can also be provided through a network such as the Internet or an electronic mail.

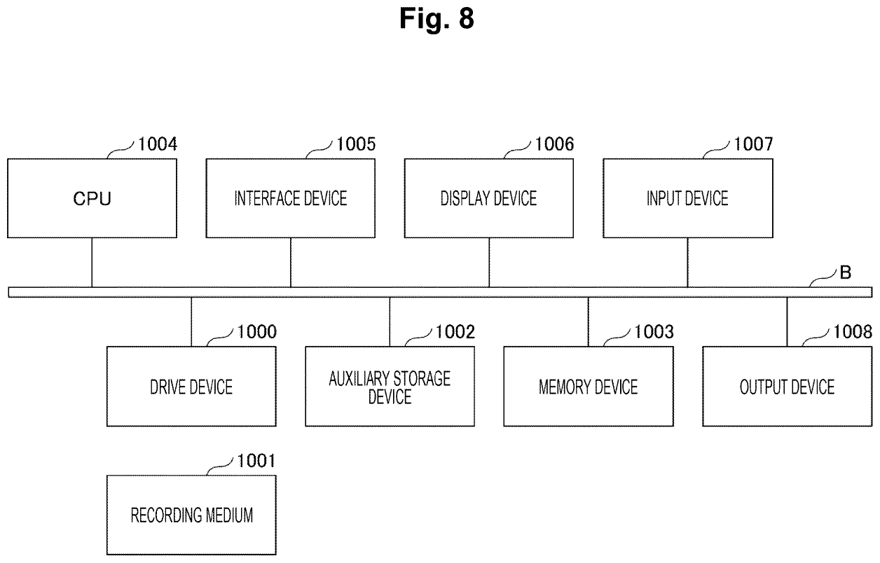

FIG. 8 illustrates a hardware configuration example of the above computer. The computer in FIG. 8 includes a drive device 1000, an auxiliary storage device 1002, a memory device 1003, a CPU 1004, an interface device 1005, a display device 1006, an input device 1007, an output device 1008, and the like, which are connected to each other via a bus BS.

The program for implementing processing in the computer is provided through, for example, a recording medium 1001 such as a CD-ROM or a memory card. When the recording medium 1001 storing the program is set in the drive device 1000, the program is installed on the auxiliary storage device 1002 from the recording medium 1001 via the drive device 1000. However, the program is not necessarily installed from the recording medium 1001 and may be downloaded from another computer via a network. The auxiliary storage device 1002 stores the installed program and also stores necessary files, data, and the like.

In a case where an instruction to start the program is made, the memory device 1003 reads the program from the auxiliary storage device 1002 and stores the program. The CPU 1004 implements a function related to the device in accordance with the program stored in the memory device 1003.

The interface device 1005 is used as an interface for connection to a network or the like. The display device 1006 displays a graphical user interface (GUI) or the like according to the program. The input device 1007 includes a keyboard and a mouse, a button, a touchscreen, and the like and is used to input various operation instructions. The output device 1008 outputs calculation results.

Note that the device need not include any one or a plurality or all of the display device 1006, the input device 1007, and the output device 1008.

### Summary and Effects of Embodiment

As described above, in the technique according to the present embodiment, the plurality of terminal devices 20 is clustered and divided into the plurality of terminal clusters, and a connection destination base station device 10 is determined for each terminal cluster. Therefore, even in a case where the number of terminal devices 20 is large, the base station device 10 to which the terminal devices 20 are connected can be determined with a small amount of operation.

### Supplementary Notes

The present specification discloses at least a wireless communication system, a control apparatus, a connection control method, and a program in the following items.

### Supplementary Note 1

A wireless communication system including one or more base station devices that communicate with one or more terminal devices and a control apparatus, in which

the control apparatus includes

a terminal cluster calculation unit that performs clustering on a plurality of terminal devices and divides the plurality of terminal devices into a plurality of clusters, and

a connection control unit that generates a plurality of combination patterns in which the base station device to be a connection destination of the terminal devices is allocated to each cluster, calculates an evaluation index value of each combination pattern, selects a combination pattern having a best evaluation index value, and performs control for connecting the terminal devices to the base station device based on the selected combination pattern.

### Supplementary Note 2

The wireless communication system according to supplementary note 1, in which

the terminal cluster calculation unit performs the clustering based on at least one of a position of each terminal device, a use application of each terminal device, or a communication requirement of each terminal device.

### Supplementary Note 3

The wireless communication system according to supplementary note 1 or 2, in which

the connection control unit uses, as the evaluation index value, at least one of a communication request achievement rate, a degree of satisfaction to a user of the terminal device, or QoE of the user of the terminal device.

### Supplementary Note 4

A control apparatus in a wireless communication system including one or more base station devices that communicate with one or more terminal devices and the control apparatus, the control apparatus including:

a memory; and

at least one processor connected to the memory, in which

the processor

performs clustering on a plurality of terminal devices and divides the plurality of terminal devices into a plurality of clusters, and

generates a plurality of combination patterns in which the base station device to be a connection destination of the terminal devices is allocated to each cluster, calculates an evaluation index value of each combination pattern, selects a combination pattern having a best evaluation index value, and performs control for connecting the terminal devices to the base station device based on the selected combination pattern.

### Supplementary Note 5

A connection control method in a wireless communication system including one or more base station devices that communicate with one or more terminal devices and a control apparatus, in which:

the control apparatus performs clustering on a plurality of terminal devices and divides the plurality of terminal devices into a plurality of clusters; and

the control apparatus generates a plurality of combination patterns in which the base station device to be a connection destination of the terminal devices is allocated to each cluster, calculates an evaluation index value of each combination pattern, selects a combination pattern having a best evaluation index value, and performs control for connecting the terminal devices to the base station device based on the selected combination pattern.

### Supplementary Note 6

A non-transitory storage medium storing a program for causing a computer to function as each unit of the control apparatus according to supplementary note 4.

While the present embodiments have been described above, the present invention is not limited to such specific embodiments, and various modifications and changes can be made within the scope of the spirit of the present invention described in the claims.

### REFERENCE SIGNS LIST

10 Base station device
11 Communication unit
12 Wireless communication unit
13 Terminal accommodation control unit
14 Wireless signal processing unit
20 Terminal device
30 Control apparatus
31 Communication unit
32 External input/output unit
33 Arithmetic processing unit
34 DB
35 Information collection unit
36 Terminal cluster calculation unit
37 Connection control unit
1000 Drive device
1001 Recording medium
1002 Auxiliary storage device
1003 Memory device
1004 CPU
1005 Interface device
1006 Display device
1007 Input device
1008 Output device

1. A wireless communication system including one or more base station devices, which communicate with one or more terminal devices, and a control apparatus, wherein
the control apparatus includes
a processor; and
a memory that includes instructions, which when executed, cause the processor to execute:
performing clustering on a plurality of terminal devices and dividing the plurality of terminal devices into a plurality of clusters, and
generating a plurality of combination patterns in which the base station device to be a connection destination of the terminal devices is allocated to each cluster, calculating an evaluation index value of each combination pattern, selecting a combination pattern having a best evaluation index value, and performing control for connecting the terminal devices to the base station device based on the selected combination pattern.

2. The wireless communication system according to claim 1, wherein
the clustering is performed based on at least one of a position of each terminal device, a use application of each terminal device, or a communication requirement of each terminal device.

3. The wireless communication system according to claim 1, wherein
the calculating includes using, as the evaluation index value, at least one of a communication request achievement rate, a degree of satisfaction to a user of the terminal device, or QoE of the user of the terminal device.

4. A control apparatus in a wireless communication system including one or more base station devices, which communicate with one or more terminal devices, and the control apparatus, the control apparatus comprising:
a processor; and
a memory that includes instructions, which when executed, cause the processor to execute:
performing clustering on a plurality of terminal devices and dividing the plurality of terminal devices into a plurality of clusters; and
generating a plurality of combination patterns in which the base station device to be a connection destination of the terminal devices is allocated to each cluster, calculating an evaluation index value of each combination pattern, selecting a combination pattern having a best evaluation index value, and performing control for connecting the terminal devices to the base station device based on the selected combination pattern.

5. A connection control method executed by a control apparatus included in a wireless communication system, the wireless communication system including one or more base station devices, which communicate with one or more terminal devices, and the control apparatus, the connection control method comprising:
performing clustering on a plurality of terminal devices and dividing the plurality of terminal devices into a plurality of clusters; and
the control apparatus generating a plurality of combination patterns in which the base station device to be a connection destination of the terminal devices is allocated to each cluster, calculating an evaluation index value of each combination pattern, selecting a combination pattern having a best evaluation index value, and performing control for connecting the terminal devices to the base station device based on the selected combination pattern.

6. (canceled)

7. A non-transitory computer-readable recording medium having computer-readable instructions stored thereon, which when executed, cause a computer including a memory and a processor to execute the connection control method according to claim 5.
